(19) United States
(12) Patent Application Publication
(10) Pub. No.: US 2026/0009370 A1
(43) Pub. Date: Jan. 8, 2026

(54) A System And Method For Fluid Gravitational Energy For Power-Generation In Sub Surface Oil, Water Injection And Disposal Wells

(71) Applicants: Cyril Girard, Hundvag (NO); Hassan Sami Suheil, Houston, TX (US)

(72) Inventors: Cyril Girard, Hundvag (NO); Hassan Sami Suheil, Houston, TX (US)

(21) Appl. No.: 19/245,046

(22) Filed: Jun. 20, 2025

Related U.S. Application Data
(60) Provisional application No. 63/662,386, filed on Jun. 20, 2024.
(60) Provisional application No. 63/693,576, filed on Sep. 11, 2024.

(51) Int. Cl. F03B 13/02; E21B 41/00; E21B 43/12; H02K 7/18

(52) U.S. Cl. CPC F03B 13/02; E21B 41/0064; E21B 43/128; H02K 7/1823

(57) ABSTRACT

A system and method for using fluid gravitational energy for power-generation in sub surface oil, water injection, CO2 Injection, Geothermal and disposal wells. This invention represents a significant advancement in the field of renewable energy generation. By integrating electricity generation capabilities into existing downhole electric submersible pumps, it offers a practical solution for reducing energy costs and enhancing the sustainability of water extraction operations.

### CROSS REFERENCE TO RELATED PATENT APPLICATIONS

This patent application claims priority from U.S. provisional patent application Ser. No. 63/662,386 filed on Jun. 20, 2024, and entitled “A System And Method For Fluid Gravitational Energy For Power-Generation In Sub Surface Oil, Water Injection And Disposal Wells” which is hereby incorporated by reference in its entirety and claims priority from U.S. provisional patent application Ser. No. 63/693,576 filed on Sep. 11, 2024, and entitled “A System And Method For Fluid Gravitational Energy For Power-Generation In Sub Surface Oil, Water Injection And Disposal Wells” which is hereby incorporated by reference in its entirety.

### BACKGROUND OF THE INVENTION

Downhole electric submersible pumps (ESP) are commonly used to lift water from significant depths. However, the energy consumed by these pumps is typically drawn from external power sources, leading to increased operational costs and environmental impact. The present invention seeks to harness the kinetic energy of water passing through these pumps to generate electricity, providing a renewable energy source that can reduce operational costs and reliance on external power.

In the U.S., total annual saltwater production in 2017 was 24.4 BBL (billion barrels). 3.88 Gt/yr of water. In 2019, water production in the Permian basin was about 10 BBL. Over the last decade, water production in the U.S. averaged about 20 BBL per year. In 2017, about 44% of produced water was injected for reservoir pressure support and 48% of produced water was disposed into deep saline formations.

### FIELD OF THE INVENTION

The present invention relates to methods and apparatuses for generating electrical energy from water flow, particularly through downhole electric submersible pumps used in various applications such as oil and gas extraction, groundwater extraction,

### SUMMARY OF THE INVENTION

In a particular illustrative embodiment of the invention, a system and method are disclosed for the generation of electricity using injected water, salt water, brine, geothermal and CO2 into a well or a multi zone well with varying elevation. This well could be a disposal well or an injection well used for IOR or EOR purpose. The invention provides a method and apparatus for converting the kinetic energy of fluid flow through a downhole electric submersible pump or a turbine/alternator into electrical energy. This is achieved through the integration of a turbine-generator assembly into the pump's design, allowing for the generation of electricity as fluid is pumped.

### BRIEF DESCRIPTION OF THE DRAWINGS

The drawings presented herein are for illustrative purposes only and do not limit the scope of the claims. Rather, the drawings are intended to help enable one having ordinary skill in the art to make and use the claimed inventions. The drawings are drawn to scale.

FIG. 1 is a conceptual depiction of an illustrative embodiment of the invention;

FIG. 2 is a schematic depiction of the illustrative embodiment of the invention;

FIG. 3 is a schematic depiction of the illustrative embodiment of the invention;

FIG. 4 is a schematic depiction of a topology for the illustrative embodiment of the invention;

FIG. 5 is a schematic depiction of a topology for the illustrative embodiment of the invention;

FIG. 6 is a schematic depiction of the illustrative embodiment of the invention;

FIG. 7 is a schematic depiction of the illustrative embodiment of the invention;

FIG. 8 is a schematic depiction of the illustrative embodiment of the invention; and

FIG. 9 is a schematic depiction of the illustrative embodiment of the invention.

### DETAILED DESCRIPTION OF AN ILLUSTRATIVE EMBODIMENT OF THE INVENTION

A detailed description will now be provided. The purpose of this detailed description, which includes the drawings, is to satisfy the statutory requirements of 35 U.S.C. § 112. For example, the detailed description includes a description of inventions defined by the claims and sufficient information that would enable a person having ordinary skill in the art to make and use the inventions. In the figures, like elements are generally indicated by like reference numerals regardless of the view or figure in which the elements appear. The figures are intended to assist with the description and to provide a visual representation of certain aspects of the subject matter described herein. The figures are not all necessarily drawn to scale, nor do they show all the structural details, nor do they limit the scope of the claims.

In an illustrative embodiment of the invention, a system is provided including but not limited to a Downhole Electric Submersible Pump: A standard ESP equipped with an pump used as PaT (Pump as turbine) or an integrated turbine assembly; A PaT or a Turbine Assembly: Located in the flow stream, designed to capture the kinetic energy of the flowing fluid, such as a liquid such as water. This may include but is not limited to: A rotor connected to a generator; A housing that directs water flow to optimize turbine efficiency; A Generator: Converts mechanical energy from the turbine into electrical energy; and A Control System: Monitors and regulates the power output and ensures safe operation.

As fluid is pumped from the surface, it flows through the turbine assembly. The kinetic energy of the moving water spins the turbine rotor. The rotor drives the generator, producing electrical energy. The generated electricity can be used to power the ESP or be fed back into the grid or stored, providing a renewable energy source.

Oil and gas extraction where power costs are significant. Groundwater extraction systems that require energy-efficient solutions. Agricultural and aquaculture systems to reduce reliance on grid power. On average, at the global level, 3 to 5 barrels of water are produced with every barrel of oil. And in certain mature regions, this figure can be as high as 10 to 14. An estimated 250 million barrels per day (Mb/d) were produced in 2008. This figure is set to exceed 300 Mb/d by 2020. Producing hydrocarbons involves producing large quantities of water.

In the present invention, the idea of this technical concept is to adapt the historical principle of hydraulic electricity storage to an Oil and Gas (O&G) well application. Existing O&G wells with depleted reservoirs (deeper than 1.000-1.500 m) are used. The condition is that those wells are flowing without or limited backpressure, while continuously injecting into the depleted zone. In this present invention, the source water or CO2 for injection is coming from surface. The source water may be processing water from O&G operations, which needs to be disposed of or used for enhanced oil recovery (EOR). In the illustrative embodiment of the invention, a well is completed with a turbine installation with an alternator, which generates electrical power on the same commercial model than existing Pumped-storage hydroelectricity (PSH). Surface water flows continuously through the tubing and turbine down into the injection horizon. By passing the water through the turbine installation, electricity is generated.

Hydraulic energy is used in the form of gravitational potential energy of water by continuously flowing from surface to a strongly depleted reservoir. In the well a turbine is installed, which is generating power via an ESP Permanent Magnet Motor PMM. Underground Injection Wells For Produced Water Disposal or Enhanced Oil Recovery (EOR) and are today a cost and volumes are a problem to manage. ESP technologies could be used to create Well pumped hydroelectricity based on well-known PSH economical model but here on continuous injection mode.

For example, a proposed installation of the invention follows:
Budgetary cost: Engineering=$100 k USD Pilot=$335 k USD
Benefit: Energy Revenue: One cubic meter of water «fall» from 3280 feet generates 2,72 KWh

The present invention reduces operating expense (OPEX) cost of Oil field as water injectors injector produces electrical energy. This create value in Underground Injection Wells For Produced Water Disposal. The surplus energy can be used for ESP or water injection pump to decrease lift cost in the same field and contribute to the reduction of Emissions NOX, CO2 EOR Solutions.

Decentralized systems in well applications provide distributed energy storage and distributed flexible electricity production and contribute to reduce the OPEX power consumption and increase energy efficiency and thereby decrease emissions. Change the value proposition for

Underground Injection Wells For Produced Water Disposal and Enhanced Oil Recovery EOR water injection.

For example, using the present invention would produce as follows: Energy Revenue: 6.29 bbl of water «fall» from 3280 feet generates 2.72 kilowatt hours (KWh). A proposed installation design: 26,000 barrels per day (blpd)=1,083 barrels per hour (b/h). In the present example an electric submersible pump (ESP) is placed at 6000 ft total vertical distance (TVD) is placed downhole in the wellbore and water feeding at OmTVD; Ratio 6000 ft/3280 ft=1,82. This generates 2.72KWh*1.82*1,083/6.29=852.35 KWh.

The business case and value created by Pumped Storage Hydroelectricity is very similar to windmill.

The sale value of KWh=0, 85235*14 US$ MWh=11.93 US$/h is the same for both renewable solutions. For the Windmill, the Return of investment depends on power generated, having the size of the wind turbines and the annual average wind speed. For the Pumped Storage Hydroelectricity, the Return of investment depends on power generated, having the flow rate of water injected in disposal well and the vertical depth the related well. The Pumped Storage Hydroelectricity power availability is not weather dependent like Solar and Wind and can be used 24/7 365 days per year.

The oil and gas industry is a very large user of disposal wells in the USA and worldwide. The operator using the Pumped Storage Hydroelectricity for his own water injection well, either for disposal or for pressure maintenance will have the following benefits. The power generated by PSH will decrease the power to be created from gas or purchased from the grid, this will decrease the OPEX by decreasing the daily power required to operate an oil field. This power created in house will be considered as green electricity as won't been create from a fossil energy and the equivalent emissions NOX and CO2 not generated could be accounted in Operator contribution for the energy transition.

The well pumped-Hydroelectricity (WPH) principle and business economics is established. The present invention provides a decentralized system in well applications for well pumped-Hydroelectricity using ESP technologies as an enabler that serve distributed flexible electricity production. Thereby the present invention contributes to the decentralized integration of intermittent renewable energy technologies, such as wind power and solar power.

In a particular illustrative embodiment of the invention, a system and method are disclosed for the generation using reinjected water, salt water and brine into a disposal well or a multi zone well with varying elevation. In a particular illustrative embodiment of the invention, a system is provided that is deployed within water disposal wells a downhole turbine at certain depth and use the injected water to generate electricity through the spinning of the turbine as water is being injected into the appropriate depth causes the turbine to spin. In the illustrative embodiment of the invention, the system is deployed within oil depleted wells, including but not limited to a turbine and a pump in a multizone reservoir with elevation differential to generate electricity at high peak rates and lift the fluid with the pump at low demand rates. Other combinations and permutations of the same concept are provided through different hardware deployments.

In the illustrative embodiment of the present invention the system is further used to inject sequestered carbon within the fluid to do two things at the same time sequester and store/dispose of CO2 from the atmosphere and generate electricity doing it using PMM motors. The present invention uses fluid gravitational energy for power-generation in sub surface oil, water injection and disposal wells; uses fluid gravitational energy for power-generation in sub surface well producing from one shallow aquifer zone to an injection zone in another geological zone then produce from previously injected deep geological zone to the shallow aquifer; uses hydraulic turbine combined with an alternator for power-generation in oil and water injection/disposal wells; uses an ESP pump stage combined with an alternator for power-generation in oil and water injection/disposal wells; uses hydraulic turbine combined with a permanent magnet motor rotating in generator mode for power-generation in oil and water injection/disposal wells; uses an ESP pump stage combined with a permanent magnet motor rotating in generator mode for power-generation in oil and water injection/disposal wells; uses an ESP motor seal section thrust bearing used for reverse rotation-and turbine mode in a power generation bundle arrangement; uses an ESP motor seal section thrust bearing used for pump rotation and reverse rotation-and turbine mode in a power generation bundle arrangement; uses 3 phases cable used to deliver power voltage and current to surface in oil and water injection/disposal wells; Uses reversible system composed of a hydraulic turbine combined to a pump coupled on the same shaft with a permanent magnet motor, rotating in one direction to generate lift and pressure to surface or aquifers shallow zone in pump mode or in the other opposite direction in turbine generative mode generate power mode in oil and water injection/disposal wells; Uses a drill pipe, tubing string, annular space, coil-tubing or wire line conveyed hydraulic turbine driving an alternator on same shaft for power-generation and connected to an electrical motor for drilling tool in oil and gas, water injection wells uses a drill pipe, coil-tubing or wire line conveyed hydraulic turbine driving a permanent magnet motor rotating in generator mode for power-generation and connected to an electrical motor for drilling tool in oil and gas, water injection wells; uses a drill pipe, coil-tubing or wire line conveyed hydraulic turbine driving an alternator on same shaft for power-generation and connected to an electrical motor for tractor intervention tool in oil and gas, water injection wells.

The present invention is used on a drill pipe, coil-tubing or wire line conveyed hydraulic turbine driving a permanent magnet motor rotating in generator mode for power-generation and connected to an electrical motor for tractor intervention tool in oil and gas, water injection wells and to power any down hole intervention or login tool. Uses an electrical frequency convertor to use electrical AC created by a hydraulic turbine combined with a permanent magnet motor rotating in generator mode for power-generation in oil and water injection/disposal wells, this AC will be converted to Electrical DC then to AC at 60 or 50 Hz grid frequency; uses of electrical frequency convertor to use electrical AC created by a hydraulic turbine combined with an alternator for power-generation in oil and water injection/disposal wells, this AC will be converted to Electrical DC then to AC at 60 or 50 Hz grid frequency.

The present invention provides an electrical frequency convertor to use electrical AC created by an ESP pump stage combined with a permanent magnet motor rotating in generator mode for power-generation in oil and water injection/disposal wells this AC will be converted to Electrical DC then to AC at 60 or 50 Hz grid frequency and uses an electrical frequency convertor to use electrical AC created by an ESP pump stage combined with an Alternator for power-generation in oil and water injection/disposal wells this AC will be converted to Electrical DC then to AC at 60 or 50 Hz grid frequency.

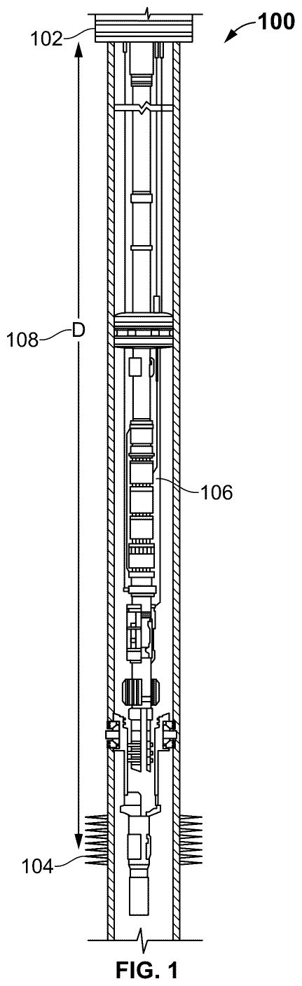

Turning now to FIG. 1, FIG. 1 is a conceptual depiction of an illustrative embodiment of the invention. As shown in FIG. 1, well pumped hydroelectricity is produced using water injection from the surface of a well bore. A water pump is provided at the surface by a traditional barrel pump A. As shown in FIG. 1, water is pumped and injected from the surface 102. A turbine alternator 106 is positioned downhole. The injection zone 104 is 9342 feet 108 below the surface 102.

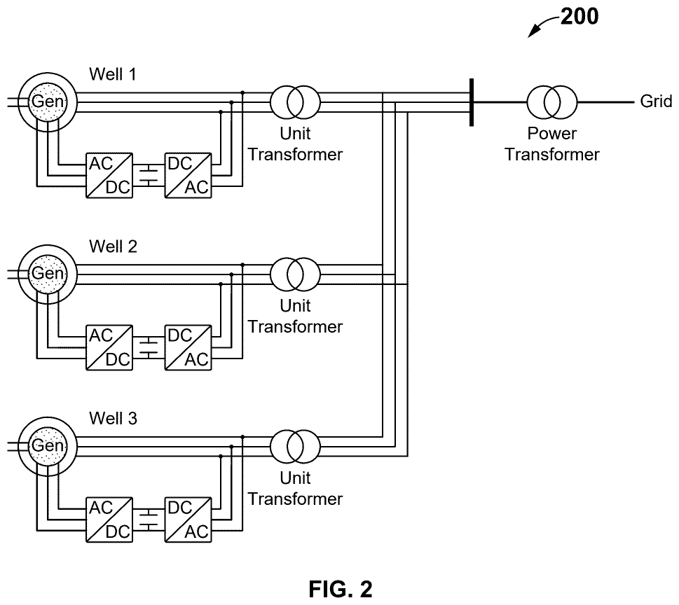

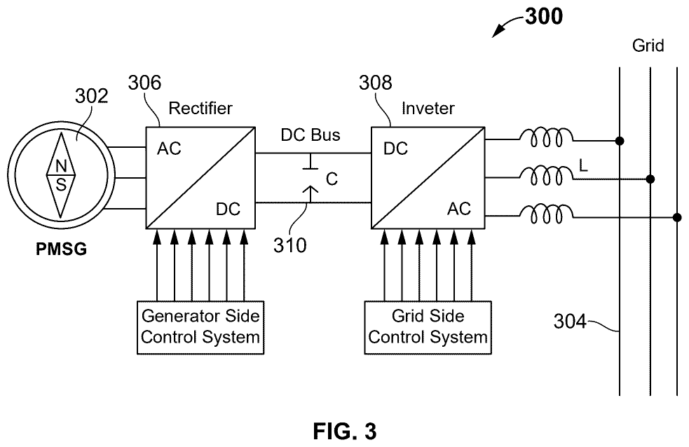

Turning now to FIG. 2 and FIG. 3, an existing wind mill micro grid set up 200 for in well hydraulic electricity power generation. The generator 202 is an alternator coupled to a hydraulic turbine both installed in an underground Injection wells for produced water disposal. As shown in FIG. 3, both asynchronous down hole generator and synchronous generator provided as an ESP permanent magnet synchronous generator (PMSG) 302. The PMSG is attached to a rectifier 306. The rectifier 306 is attached to a DC bus 310. The DC bus passes power from the rectifier 306 to an inverter 308. The inverter supplies power to the electrical grid 304.

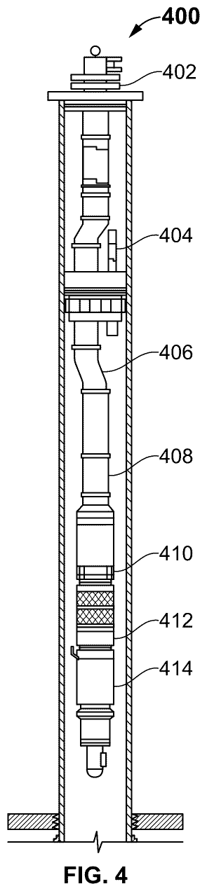

Turning now to FIG. 4, FIG. 4 depicts a first topology 400 for the illustrative embodiment of the invention. As shown in FIG. 4, FIG. 4 depicts an injector well 401 with an installed turbine and alternator. As shown in FIG. 4, a well head 402, adjustable union 406, sliding sleeve 408, ESP pump 410, gas separator 412 and ESP motor 414 are provided.

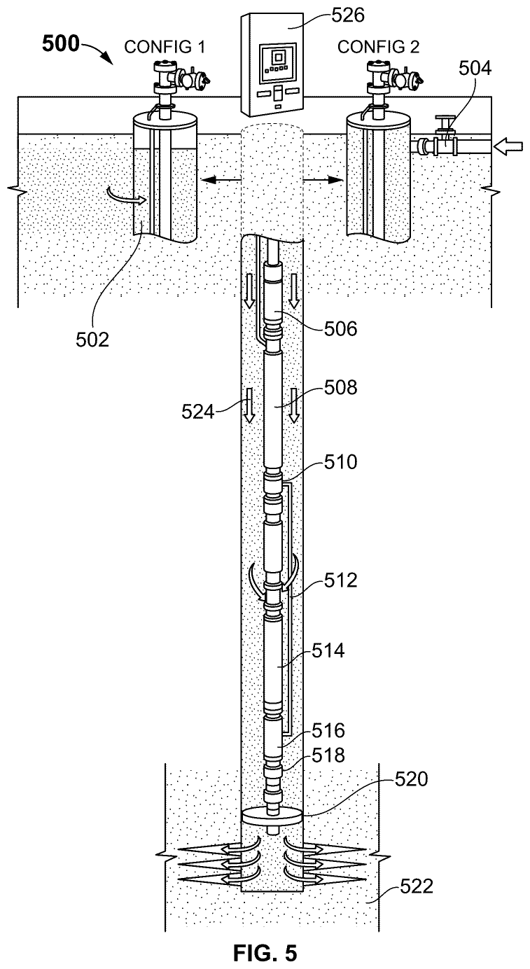

Turning now to FIG. 5, FIG. 5 depicts a second topology 500 for the illustrative embodiment of the invention. As shown in FIG. 5, FIG. 5 depicts an injector well with an installed turbine and alternator. As shown in FIG. 5, a first configuration provides water from a water bearing formation 502. In a second configuration water is provided from a surface pipeline 504. The water from the water bearing formation and the surface pipeline flows down 524. A Variable speed drive (VSD) 526 is provided. VSDs are used to control electrical submersible pumping (ESP) systems and surface pumps. The VSD enables adjustments to be made to production parameters and ESP output when downhole conditions change. An inverted compensator 506, permanent magnet motor 508, UMB with down hole sensor 510, communication line 512, inverted electric submersible pump 514, downhole flow meter 516, check valve 518 and formation to be pressurized is provided. The water flows downhole through the inverted electric submersible pump to generate electricity. The variable speed drive has a processor 527 with a non-transitory computer readable medium, wherein a computer program of computer executable instructions stored in the non-transitory computer readable medium, wherein the computer program is executed by the processor. The processor attached to the turbine is configured to optimize water flow through the turbine to maximize energy generation and capture. Inverted means the turbine is below PMM or generator.

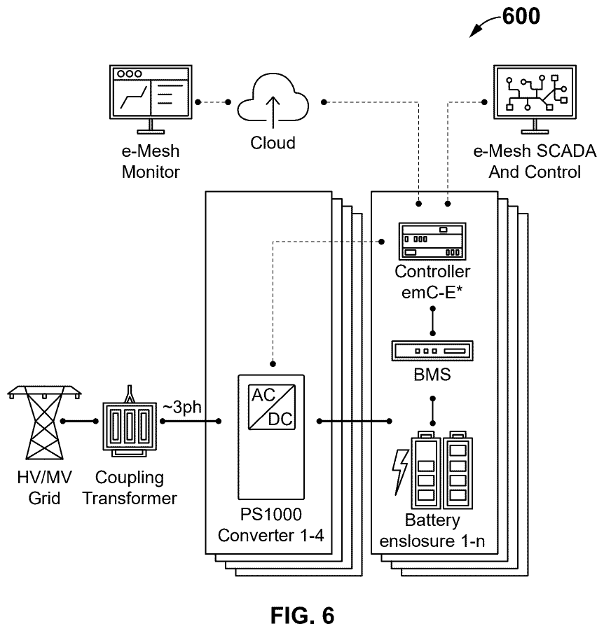

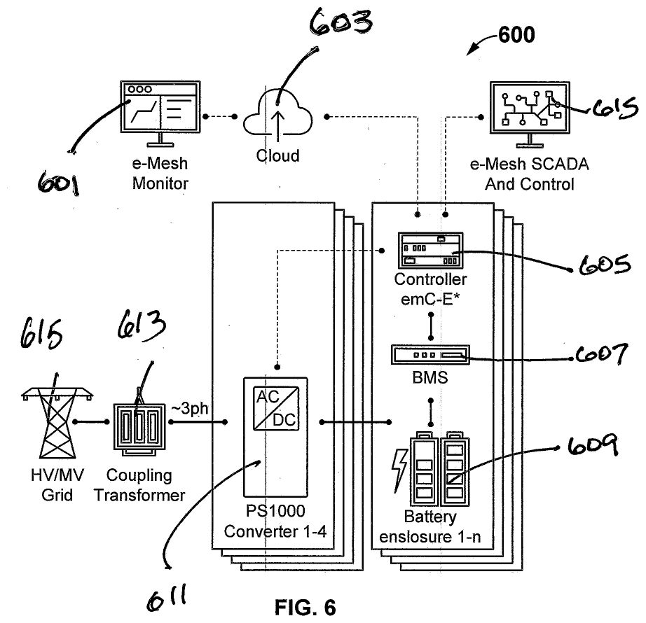

Turning now to FIG. 6, as shown in FIG. 6, in a particular illustrative embodiment of the invention, an e-Mesh monitor 601 is connected to a cloud 603 which connected to a controller emC-E* 605. The controller emC-E* communicates with an e-Mesh SCADA and Control 615 and PS1000 Converter 1-4 611. An HV/MV grid 615 is connected to coupling transformer 613.

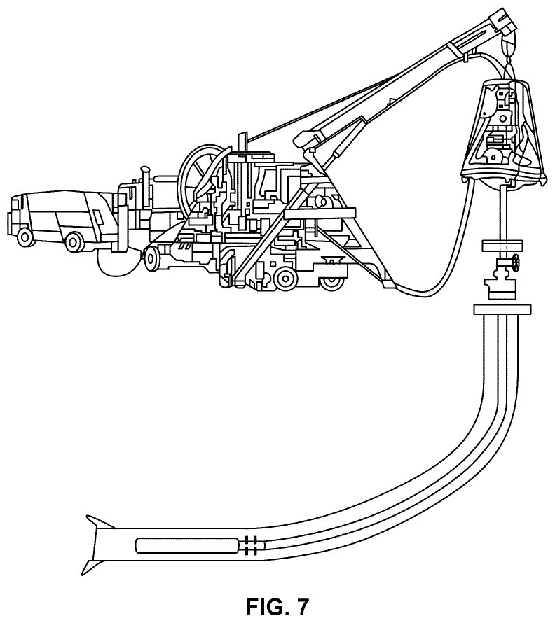

Turning now to FIG. 7, as shown in FIG. 7, in a particular illustrative embodiment of the invention, a logging truck 701 has a coiled tube injector 703 connected to a lubricator 709 attached to a blowout preventor wellhead. Coiled tubing 709 connected between the coiled tube injector and a shear-out sub with check valve a circulating ports 705 which is connected to a logging tool.

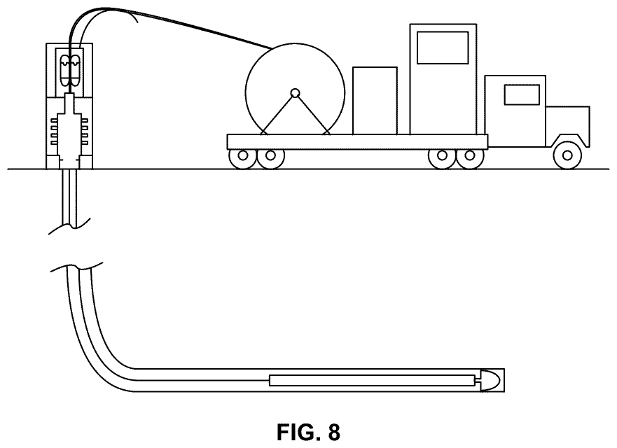

Turning now to FIG. 8, as shown in FIG. 8, a control unit 801 is connected to a power source 803. A reel 805 spools coiled tubing 809 into a guide 808 though which the coiled tubing enters injector 807 and pressure containment device 810. The coiled tubing is connected to orienting device 811, data sensors 813 and bit 815.

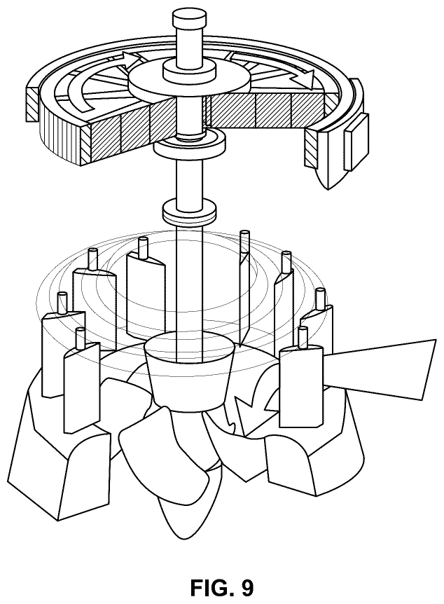

Turning now to FIG. 9, a generator 901 has stator 903, rotor 905 and shaft 907. The shaft 907 runs through turbine 909 having wicket gate 911 and blades 915 which are turned by water flow 915.

Each of the appended claims defines a separate invention which, for infringement purposes, is recognized as including equivalents of the various elements or limitations specified in the claims. Depending on the context, all references below to the “invention” may in some cases refer to certain specific embodiments only. In other cases, it will be recognized that references to the “invention” will refer to the subject matter recited in one or more, but not necessarily all, of the claims. Each of the inventions will now be described in greater detail below, including specific embodiments, versions, and examples, but the inventions are not limited to these specific embodiments, versions, or examples, which are included to enable a person having ordinary skill in the art to make and use the inventions when the information in this patent is combined with available information and technology. Various terms as used herein are defined below, and the definitions should be adopted when construing the claims that include those terms, except to the extent a different meaning is given within the specification or in express representations to the Patent and Trademark Office (PTO). To the extent a term used in a claim is not defined below or in representations to the PTO, it should be given the broadest definition persons having skill in the art have given that term as reflected in at least one printed publication, dictionary, or issued patent.

Certain specific embodiments of methods, structures, elements, and parts are described below, which are by no means an exclusive description of the inventions. Other specific embodiments, including those referenced in the drawings, are encompassed by this application and any patent that is issued therefrom.

1. A system for generating electricity, the system comprising:
an injection well having a surface;
a liquid that flows into the injection well;
a turbine installed in the well, wherein the turbine is positioned below the surface;
a generator attached to the turbine and wherein the liquid flows through the turbine that causes the turbine to spin the generator thereby generating electricity.

2. The system for generating electricity as claimed in claim 1, the system further comprising:
a processor attached to the turbine, wherein the processor is configured to optimize water flow through the turbine to maximize energy generation and capture.

3. The system for generating electricity as claimed in claim 1, further comprising:
a permanent magnet motor in the well and attached to the turbine wherein the turbine spins the permanent magnet motor in generator mode to generate electricity.

4. The system for generating electricity as claimed in claim 1, wherein the turbine is an electrical submersible pump.

5. The system for generating electricity as claimed in claim 4, wherein the turbine electrical submersible pump is inverted.

6. The system for generating electricity of claim 1, the system further comprising:
a surface pump that configured to flow the liquid from the surface into the injection well.

7. The system of claim 1 for generating electricity further comprising:
a liquid bearing formation configured to flow the liquid from the liquid bearing formation into the injection well wherein the systems uses fluid gravitational energy for power-generation in sub surface well producing from one shallow aquifer zone to an injection zone in another geological zone then produce from previously injected deep geological zone to the shallow aquifer.

8. The system of claim 1 for generating electricity wherein the liquid is water.

9. The system of claim 1 for generating electricity, further comprising:
an electrical grid attached to the system wherein the electricity that is generated by the system supplies power to the electrical grid.

10. A method for generating electricity, the method comprising:
injecting a liquid into an injection well; and
generating electricity from the liquid injected into the injection well.

11. The method of claim 10 method for generating electricity, the method further comprising:
injecting sequestered carbon within a fluid to sequester and store/dispose of CO2 from an atmosphere; and
generating electricity from the fluid using permanent magnet motors.

12. The method for generating electricity of claim 10, the method further comprising:
using fluid gravitational energy for power-generation in sub surface oil, water injection and disposal wells.

13. The method for generating electricity of claim 10, the method further comprising:
using fluid gravitational energy for power-generation in sub surface well producing from one shallow aquifer zone to an injection zone in another geological zone then produce from previously injected deep geological zone to the shallow aquifer.

14. The method for generating electricity of claim 10, the method further comprising:
using hydraulic turbine combined with an alternator for power-generation in oil and water injection/disposal wells.

15. The method for generating electricity of claim 10, the method further comprising:
using an Electrical submersible pump stage combined with an alternator for power-generation in oil and water injection/disposal wells.

16. The method for generating electricity of claim 10, the method further comprising:
using a hydraulic turbine combined with a permanent magnet motor rotating in generator mode for power-generation in oil and water injection/disposal wells.

17. The method for generating electricity of claim 10, the method further comprising:
using an electrical submersible pump pumping stage combined with a permanent magnet motor rotating in generator mode for power-generation in oil and water injection/disposal wells.

18. The method for generating electricity of claim 10, the method further comprising:
using an electrical submersible motor seal section thrust bearing used for reverse rotation-and turbine mode in a power generation bundle arrangement.

19. The method for generating electricity of claim 10, the method further comprising:
using an ESP motor seal section thrust bearing used for pump rotation and reverse rotation-and turbine mode in a power generation bundle arrangement

20. The method for generating electricity of claim 10, the method further comprising:
using a reversible system composed of a hydraulic turbine combined to a pump coupled on a shaft with a permanent magnet motor, rotating in one direction to generate lift and pressure to surface or aquifers shallow zone in pump mode or in an opposite direction in turbine mode generate power mode in oil and water injection/disposal wells.

21. A method for generating electricity, the method comprising:
using a at least one of a drill pipe, coil-tubing and wire line conveyed hydraulic turbine driving an electrical generator on same shaft for power-generation and connected to an electrical motor for drilling tool in oil and gas, water injection wells.

22. The method of claim 21, wherein, the electrical generator is at least one of a alternator, a permanent magnet motor rotating in generator mode for power-generation and connected to an electrical motor for drilling tool in oil and gas, water injection wells claims 23. The method of claim 21, further comprising:
using a drill pipe, coil-tubing or wire line conveyed hydraulic turbine driving a permanent magnet motor rotating in generator mode for power-generation and connected to an electrical motor for tractor intervention tool in oil and gas, water injection wells. Claims 24. A system for generating electricity, the system comprising:
an alternator on same shaft for power-generation and connected to an electrical motor for tractor intervention tool in oil and gas, water injection wells.
